(19) United States
(12) Patent Application Publication
(10) Pub. No.: US 2013/0120706 A1
(43) Pub. Date: May 16, 2013

(54) OPTICAL DEVICE AND CHARGING SYSTEM INCLUDING THE SAME

(71) Applicants: Akira Kakinuma, Osaka (JP); Keisuke Yoneda, Osaka (JP); Fumio Kato, Osaka (JP)

(72) Inventors: Akira Kakinuma, Osaka (JP); Keisuke Yoneda, Osaka (JP); Fumio Kato, Osaka (JP)

(73) Assignee: PANASONIC CORPORATION, Osaka (JP)

(21) Appl. No.: 13/808,200

(22) PCT Filed: Jun. 13, 2011
(86) PCT No.: PCT/JP2011/003340

§ 371 Date: Jan. 3, 2013

(30) Foreign Application Priority Data
Aug. 9, 2010 (JP) 2010-178294

(51) Int. Cl. G02C 7/08; G02F 1/13; G02C 11/00

(52) U.S. Cl. CPC G02C 7/083; G02C 11/10; G02F 1/1313
USPC 351/158; 349/13

(57) ABSTRACT

An optical device including: one or more optical components configured to be electrically actuated such that light transmission states are variable, a driver circuit for the optical components, a power source unit for driving the optical components, a pair of rims for supporting the optical components, a pair of temples having front and rear ends and being connected at the front ends to the pair of rims, and a pair of earpieces formed at the rear ends of the pair of temples. The power source unit includes a secondary battery, and a power receiver coil for charging the secondary battery. The secondary battery includes a case made of a non-magnetic material.

### TECHNICAL FIELD

The present invention relates to optical devices, more specifically to a technology for improving the convenience of use of a head mounted optical device to be worn on the head of a user.

### BACKGROUND ART

Some stereoscopic image viewing devices (hereinafter simply referred to as “viewing devices”) generally called 3D eyeglasses or 3D glasses support an active system, and some support a passive system.

The active system is a system in which on a display device such as a television, right-eye and left-eye images are alternately switched and displayed, while on a viewing device, liquid crystal shutters or the like provided on right and left lens portions are alternately opened and closed in synchronization with the switching of images on the display device (see Patent Literatures 1 and 2).

The active system allows viewing stereoscopic image by using a display device having almost the same structure as that of the conventional display device, and simply by changing the image data to be displayed on the display device into stereoscopic image data.

On the other hand, in the passive system, right-eye and left-eye images are simultaneously displayed line by line on a display device, and in the display device, the images are sorted into those for the right eye and those for the left eye. Then, the sorted images are respectively delivered to the right eye and the left eye through specialized eyeglasses. Accordingly, in the passive system, 3D images cannot be properly viewed unless the images are viewed in the vicinity of the front of the display device. Moreover, since the right-eye and left-eye images are simultaneously displayed on the same screen, the resolution is low. It can be said, therefore, that for viewing on a household television, the active stereoscopic image viewing system is more preferable for the user.

Furthermore, a technology of using eyeglass lenses including electroactive elements made of liquid crystals and adjusting the current to be applied to the electroactive elements, thereby to instantaneously change the diopter (refractive power) or focal point of the lenses is gathering attention (see Patent Literatures 3, 4, and 5). This technology realizes eyeglasses (hereinafter referred to as “variable focus eyeglasses”) in which the power of the myopia correction eyeglass lenses can be locally changed to a diopter for hyperopia correction as necessary, or the diopter of almost the entire eyeglass lenses can be switched between diopters for myopia correction and hyperopia correction as necessary. This makes it possible to achieve a satisfactory field of view without distortion, as compared to the conventional so-called bifocal eyeglasses and the like.

### CITATION LIST

### Patent Literatures

Patent Literature 1: Japanese Laid-Open Patent Publication No. 2010-022067

Patent Literature 2: Japanese Laid-Open Patent Publication No. 2010-020898

Patent Literature 3: Japanese PCT National Phase Laid-Open Patent Publication No. 2010-517082

Patent Literature 4: Japanese PCT National Phase Laid-Open Patent Publication No. 2009-540386

Patent Literature 5: Japanese PCT National Phase Laid-Open Patent Publication No. 2010-522903

### SUMMARY OF INVENTION

### Technical Problem

However, in the active system, the viewing device is required to include liquid crystal shutters and a power source for driving them, and the viewing device becomes heavier and bulkier than normal eyeglasses. Therefore, quite a few users feel discomfort from wearing the viewing device.

Under these circumstances, for the active stereoscopic image viewing system, reduction in weight of the viewing device is desired in order to improve the comfort of wearing. Currently, it is popular to use a small and lightweight coin battery (primary battery) as a driving power source for optical shutters. In order to achieve a further reduction in weight of the viewing device, studies are under way to use, as a driving power source, a laminate battery which is easy to be made thinner in thickness than a coin battery.

While the normal eyeglass lenses are usually made of light-weight plastic, the active viewing device includes liquid crystal optical shutters, instead of lenses. Therefore, the weight of the viewing device inevitably becomes heavier than that of the normal eyeglasses. As such, even if reduction in weight of the viewing device can be achieved by using a coin battery or laminate battery, the discomfort felt by the user from wearing the viewing device cannot be completely eliminated simply by reducing the weight.

Moreover, the reduction in weight of the battery leads to a reduction in capacity. An excessive reduction in weight of the battery will necessitate a frequent replacement of the battery. This can be a cause to make the user feel other discomfort.

One option to solve this is to use a secondary battery as a driving power source for the viewing device. Using a secondary battery as a driving power source can reduce the frequency of replacing the battery.

However, in the case of using a secondary battery as a power source, it is necessary to provide the viewing device with a terminal for charging the battery. The terminal for charging should be arranged on the outside surface of the viewing device, which limits the design of the viewing device.

In the aforementioned variable focus eyeglasses also, there is a plan to include a secondary battery for obtaining current to be applied to the liquid crystal materials. Due to the inclusion a secondary battery, the weight thereof inevitably becomes heavier than that of the normal eyeglasses, and a terminal for charging the secondary battery need be provided on the outside surface of the eyeglasses, as is the case of the aforementioned viewing device.

In view of the above, the present invention intends to provide an optical device with a built-in battery, which is free of inconvenience such as limitation on design, even though a secondary battery is used as a driving power source.

### Solution to Problem

One aspect of the present invention relates to an optical device including: one or more optical components configured to be electrically actuated such that light transmission states are variable, a driver circuit for the optical components, a power source unit for driving the optical components, a pair of rims for supporting the optical components, a pair of temples having front and rear ends and being connected at the front ends to the pair of rims, and a pair of earpieces formed at the rear ends of the pair of temples. The power source unit includes a secondary battery, and a power receiver coil for charging the secondary battery. The secondary battery including a case made of a non-magnetic material.

For example, one aspect of the present invention relates to a stereoscopic image viewing device including: a right-eye optical shutter, a left-eye optical shutter, a driver circuit for the right-eye and left-eye optical shutters, a power source unit for driving the right-eye and left-eye optical shutters, a pair of rims for supporting the right-eye and left-eye optical shutters, a pair of temples having front and rear ends and being connected at the front ends to the pair of rims, and a pair of earpieces formed at the rear ends of the pair of temples. The power source unit includes a secondary battery, and a power receiver coil for charging the secondary battery. The secondary battery including a case made of a non-magnetic material.

Another aspect of the present invention relates to a charging system including: the aforementioned optical device; and a charger including a holder for holding the optical device in a predetermined posture, and a power transmitter coil for charging the secondary battery, in cooperation with the power receiver coil. The holder holds the optical device in such a posture that the power receiver coil faces the power transmitter coil.

### Advantageous Effects of Invention

According to the optical device of the present invention, since a power receiver coil is provided, non-contact charging of the secondary battery is possible. Therefore, there is no need to provide a terminal for charging on the outside surface of the viewing device, and the design can be easily improved. In addition, since the case of the secondary battery is made of a non-magnetic material, the magnetic field around the receiver coil will not be disturbed even when the secondary battery is disposed in proximity to the receiver coil, and the secondary battery can be charged with high efficiency. This allows the secondary battery and the receiving coil to be arranged more freely.

As a result, for example, it is possible to arrange the secondary battery and the receiver coil in the same temple, i.e., one of the right and left temples, as closely to each other as possible. This makes it possible to shorten the length of the wiring connecting them to each other. Therefore, failures due to disconnection or the like become unlikely to occur, and a highly reliable optical device can be realized.

While the novel features of the invention are set forth particularly in the appended claims, the invention, both as to organization and content, will be better understood and appreciated, along with other objects and features thereof, from the following detailed description taken in conjunction with the drawings.

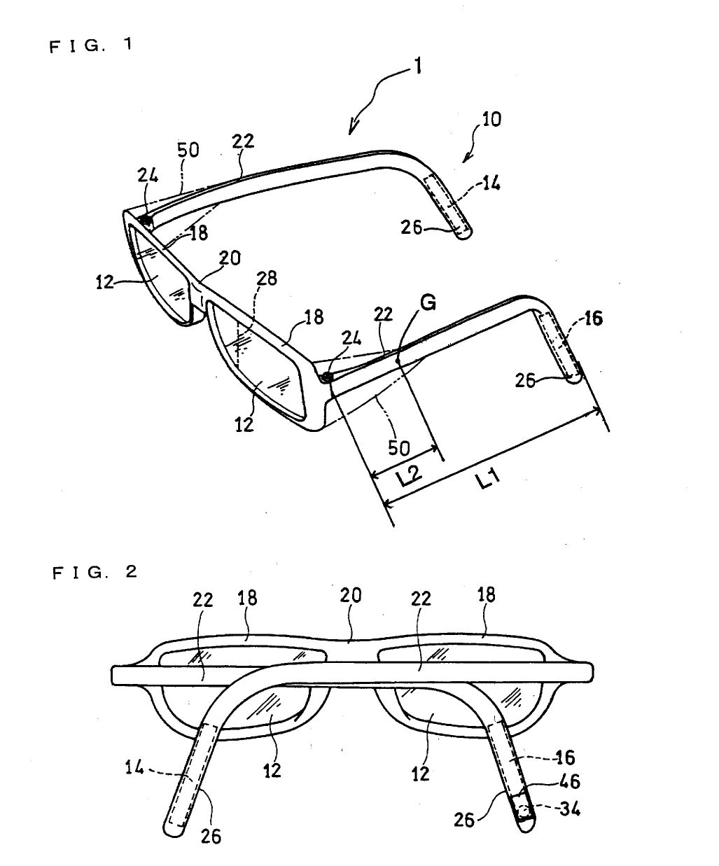

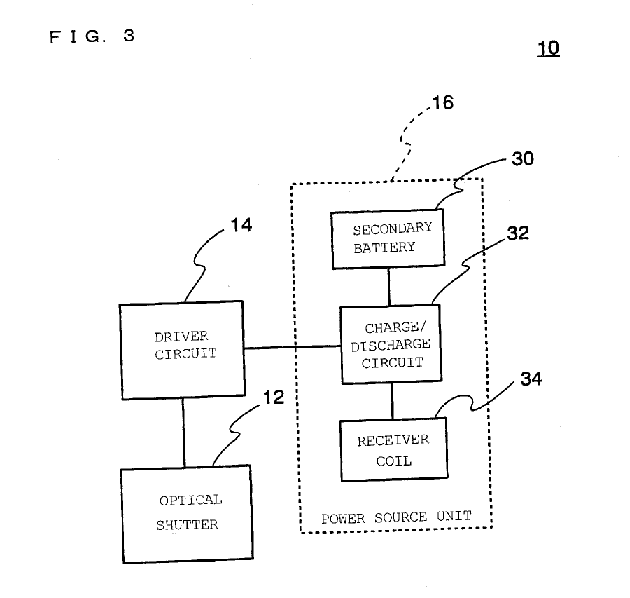

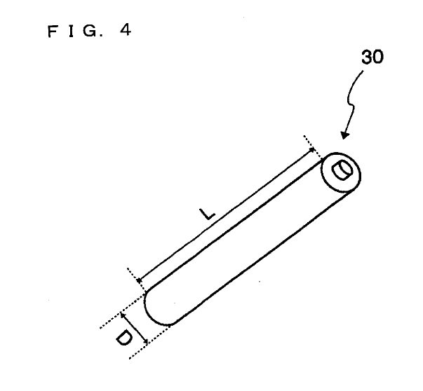

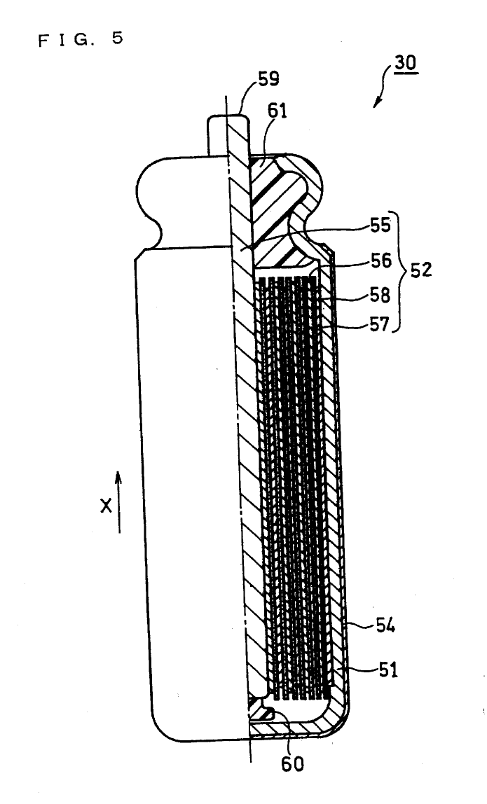

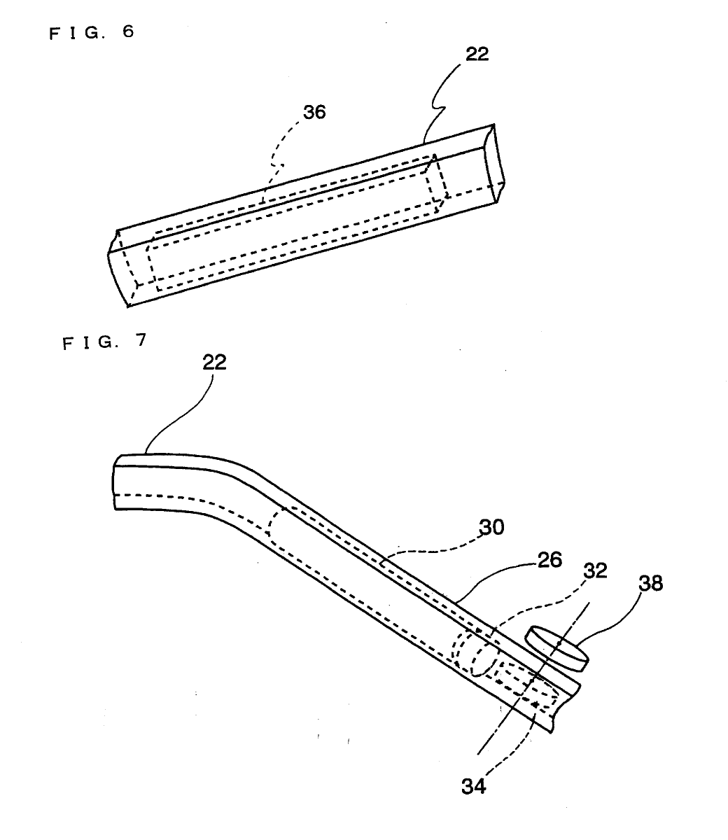

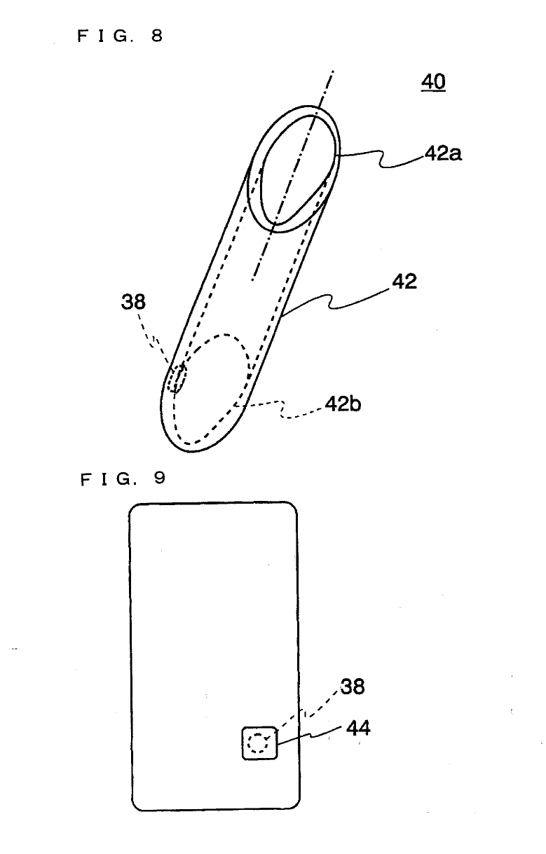

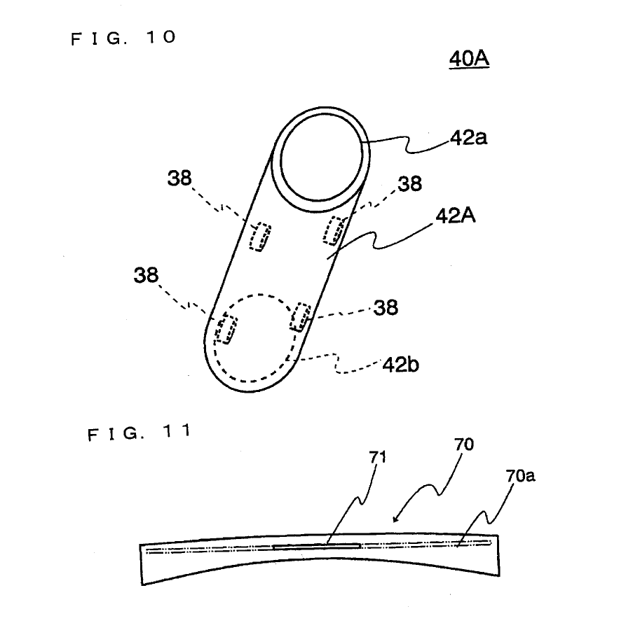

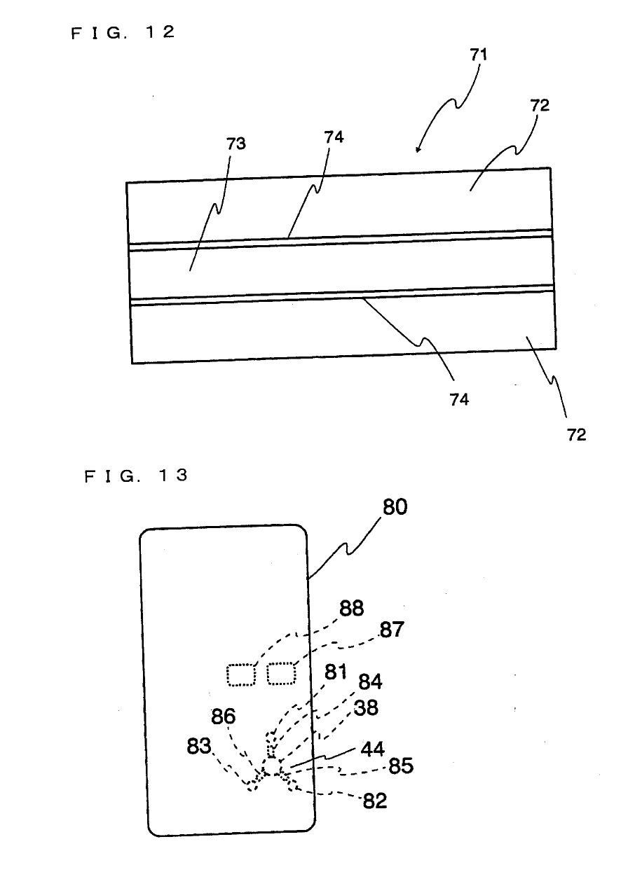

### BRIEF DESCRIPTION OF DRAWINGS

[FIG. 1] An oblique view illustrating the appearance of a stereoscopic image viewing device being an optical device according to an embodiment of the present invention

[FIG. 2] A rear view of the viewing device of FIG. 1, with the temples being folded

[FIG. 3] A functional block diagram of the stereoscopic image viewing device of FIG. 1

[FIG. 4] An oblique view illustrating the appearance of a secondary battery

[FIG. 5] A partially exploded side view illustrating exemplary details of the secondary battery

[FIG. 6] An enlarged oblique view of a temple, schematically illustrating the configuration of a housing portion for a power source unit and a driver circuit

[FIG. 7] An enlarged oblique view of an earpiece, illustrating the configuration of a charging mechanism

[FIG. 8] An oblique view of an exemplary charger

[FIG. 9] A side view of the charger of FIG. 8

[FIG. 10] An oblique view of another exemplary charger

[FIG. 11] A diagram schematically illustrating a lens for use in variable focus eyeglasses being an optical device according to another embodiment of the present invention, as viewed from a direction perpendicular to an incident direction of light

[FIG. 12] A diagram schematically illustrating a layered structure of an electroactive element for use in the variable focus eyeglasses

[FIG. 13] A side view of yet another exemplary charger

### DESCRIPTION OF EMBODIMENTS

The present invention relates to an optical device including: one or more optical components configured to be electrically actuated such that light transmission states are variable, a driver circuit for the optical components, a power source unit for driving the optical components, a pair of rims for supporting the optical components, a pair of temples having front and rear ends and being connected at the front ends to the pair of rims, and a pair of earpieces formed at rear ends of the pair of temples.

The power source unit includes a secondary battery, and a power receiver coil for charging the secondary battery. The secondary battery includes a case made of a non-magnetic material.

In the case of using a secondary battery as the power source unit for driving the optical components, it is necessary to provide the viewing device with a terminal for charging the battery. The terminal for charging should be disposed on the outside surface of the viewing device, which limits the design of the viewing device.

In order to eliminate such inconvenience, the secondary battery is charged by non-contact charging, which is capable of charging without terminals. There are three typical non-contact charging systems: electromagnetic induction system, radio wave receiving/transmitting system, and resonance system. Currently popular is the electromagnetic induction system in which electricity is supplied from a coil (transmitter coil) to a coil (receiver coil).

It is to be noted, however, that in the electromagnetic induction system, countermeasures must be taken against possible reduction in efficiency due to displacement of the two coils, overheat due to entry of impurities, and leakage of electromagnetic waves and high frequency waves. Moreover, the electromagnetic induction system involves a problem that the presence of a magnetic material near the coil, if any, may distort the magnetic field, resulting in reduced charging efficiency.

Therefore, generally, the secondary battery including an electromagnetic material is usually arranged a certain distance away from the receiver coil. However, if the secondary battery and the receiver coil are arranged apart from each other, the wiring therebetween becomes longer accordingly, which increases the risk of disconnection. As a result, the reliability of connection will be reduced, causing increased malfunctions. In addition, the charging efficiency also will be reduced by power loss.

In the present invention, the secondary battery includes a case made of a non-magnetic material. Therefore, even when the secondary battery and the receiver coil are arranged in proximity to each other, the secondary battery can be charged with high efficiency without distorting the magnetic field around the receiver coil. This makes it possible, for example, to arrange the secondary battery and the receiver coil in the same temple in proximity to each other, and thus shorten the length of the connecting wiring between the secondary battery and the receiver coil. Consequently, the risk of disconnection is reduced, and a highly reliable viewing device which is unlikely to malfunction can be realized. Here, the “non-magnetic material” is a material which is not ferromagnetic, and includes a paramagnetic material and a diamagnetic material. In terms of the magnetic permeability, ferromagnetic materials have a magnetic permeability of 100 to 500, while non-magnetic materials have a magnetic permeability of nearly 1.

In an optical device according to one embodiment of the present invention, the secondary battery and the receiver coil are provided near the rear end of the same temple or in the same earpiece. A distance L2 between the front end of the temple and a center of gravity G of the optical device along a direction in which the temple extends is 15 to 50% of a distance L1 between the front end of the temple and the rear end of the earpiece along the direction in which the temple extends. A more preferred range of the above is 20 to 35%.

For example, in an eyeglasses-like stereoscopic image viewing device, it is preferable to use liquid crystal optical shutters for the right-eye and left-eye optical shutters, in view of the open and close speed and quietness of the shutters. However, liquid crystal shutters are heavier (e.g., 6 to 15 g per lens) than plastic lenses of normal eyeglasses (for lightweight lenses, 4 to 7 g per lens).

In the eyeglasses-like stereoscopic image viewing device, heavy liquid crystal optical shutters are disposed on the front side. Accordingly, the center of gravity of the device is closer to the front than that of the normal eyeglasses. Moreover, in the conventional viewing device, as indicated in FIG. 1 by the dash-dot-dot line, a broad portion 50 is formed at the front end of the temple, and a coin battery (primary battery) or laminate battery is provided in the broad portion 50. As such, the center of gravity of the stereoscopic image viewing device is further closer to the front.

In general, eyeglasses are supported on the wearer's nose and ears. When the weight of the viewing device is imbalanced toward the front, the weight of the viewing device is mainly put on the nose, and the viewing device frequently slides down due to perspiration or slight movement of the head. As a result, the comfort of wearing is extremely impaired.

Therefore, in one embodiment of the present invention, the battery used for the power supply unit is disposed on the rear side (close to the rear end of the temple or in the earpiece) away from the optical elements such as lens-like liquid crystal optical shutters disposed on the front side of the optical device. By arranging like this, the optical device can have a good weight balance. Accordingly, the comfort of wearing the optical device is improved.

At this time, since the case of the secondary battery is made of a non-magnetic material, the secondary battery and the receiver coil can be concentrated on the rear side of the same temple or in the earpiece, without distorting the magnetic field. Therefore, as compared to the case where the secondary battery and the receiver coil are arranged on the rear sides of the different temples or the like, the length of the wiring therebetween can be considerably shortened.

In a stereoscopic image viewing device according to another embodiment of the present invention, the secondary battery is cylindrical or rectangular, and has a diameter or width of 2 to 6 mm. As such, even though the secondary battery is incorporated into the temple or the like, it is not necessary to make the temple or the like particularly wide. Therefore, the secondary battery can be arranged near the rear end of the temple or in the earpiece, without sacrificing the design.

Cylindrical or rectangular batteries generally include a case being a metal can. These batteries are resistive to an increase in internal pressure because of their shape, and therefore, even though the volume thereof is small, can accommodate a large amount of material. Moreover, they are highly resistant to external force, and therefore, are suitable for being incorporated into the bendable portion of the optical device, such as temples and earpieces. Here, the term “rectangular” refers to a shape corresponding to a so-called “prismatic battery” in the field of batteries, and may be any shape that includes a tubular portion having a pair of parallel flat plate-like portions. The “rectangular” shape includes a thin flat shape with the sides rounded like an arc. In the case where the rectangular secondary battery has two different widths, large and small, the “width” of the rectangular secondary battery herein refers to a small width.

By setting the distance between the secondary battery and the receiver coil to 4 cm or less, the length of the wiring connecting them to each other can be shortened considerably. This can significantly reduce the risk of disconnection, and minimize the power loss that would otherwise increase due to a long wiring length. As a result, the secondary battery can be charged with higher efficiency.

Examples of the non-magnetic material include austenitic stainless steel, high manganese non-magnetic steel, simple substance of aluminum or titanium, and alloys of these. Nickel in the form of simple substance is a ferromagnetic material, whereas, for example, a nickel-containing metal such as SUS316 (stainless steel) is a non-magnetic material. Therefore, nickel, if used in the form of an alloy, also can be used as a non-magnetic material.

As mentioned above, one example of the optical device of the present invention is a viewing device such as so-called 3D glasses, wherein one example of the optical elements is a pair of liquid crystal optical shutters for the right and left eyes. The liquid crystal optical shutters are supported on a pair of rims. The driver circuit applies a variable voltage to each of the pair of liquid crystal optical shutters in synchronization with switching between two images, such as right-eye and left-eye images, which are alternately displayed on an external image display device. At this time, the voltage to be applied to each liquid crystal optical shutter is varied such that when the degree of transparency of one of the pair of liquid crystal optical shutters is high, the degree of transparency of the other is low, and when the degree of transparency of one of the pair of liquid crystal optical shutters is low, the degree of transparency of the other is high.

Another example of the optical device of the present invention includes an electroactive material whose refractive index varies upon activation through application of a voltage greater than or equal to a predetermined value. The driver circuit activates the electroactive material by applying a voltage greater than or equal to the predetermined value to the electroactive material under a predetermined condition. Here, the predetermined condition is, for example, an instruction provided by the user's button operation or an instruction from a sensor means for sensing the user's predetermined action (e.g., the action of lowering the head). Examples of the electroactive material include a cholesteric liquid crystal material.

The present invention further relates to a charging system including the aforementioned optical device, and a charger. The charger includes a holder for holding the optical device, and a power transmitter coil. The holder holds the optical device in such a posture that the power receiver coil faces the power transmitter coil. The transmitter coil charges the secondary battery, in cooperation with the receiver coil.

In a charging system according to one embodiment of the present invention, each of the pair of temples is connected at the front end thereof to the outside edge of each of the pair of rims so as to be foldable about a hinge. The holder of the charger is a tubular member having an opening at one end thereof and has a bottom at the other end thereof. The holder holds the optical device with the pair of temples being folded, within the tubular member in such a state that the outside edge of one of the rims is directed toward the opening, and the outside edge of the other of the rims is directed toward the bottom. The transmitter coil is disposed at a position in proximity to the receiver coil, or preferably, at a position coaxially facing the receiver coil, while the optical device is being held within the tubular member.

This configuration enables charging of the secondary battery simply by inserting the optical device with the temples being folded, into the holder comprising a tubular member while an alternating current of the predetermined voltage is passed through the coil, in the direction appropriate for positioning the receive coil and the transmitter coil in proximity to or face to face each other.

In a charging system according to another embodiment of the present invention, the temple or the earpiece provided with the receiver coil has a first mark indicating the position where the receiver coil is provided, and the tubular member has a second mark indicating the position where the transmitter coil is provided. This allows the user to easily find out the appropriate direction for inserting the optical device such that the receiver coil and the transmitter coil are positioned in proximity to or face to face each other.

The opening of the tubular member preferably has an asymmetric shape, so that when the optical device with the temples being folded is to be held within the tubular member, orientations of the optical components (the front side) and the temples (the back side) and orientations of one and the other of the rims of the optical device are determined by the shape of the opening. This allows the user to set the optical device within the tubular member, without erroneously reversing the front and the back or reversing the top (one of the rims) and the bottom (the other of the rims) of the optical device, and without misalignment.

In a charging system according to yet another embodiment of the present invention, each of the pair of temples is connected at the front end thereof to the outside edge of each of the pair of rims so as to be foldable about a hinge. The holder of the charger is a tubular member having an opening at one end thereof and has a bottom at the other end thereof. The secondary battery and the receiver coil are provided near the rear end of the temple or in the earpiece. The holder holds the optical device with the temples being folded, within the tubular member in such a posture that the outside edge of one of the rims is directed toward the opening, and the outside edge of the other of the rims is directed toward the bottom. At least four transmitter coils are provided, and they are disposed at a pair of positions near the bottom and a pair of positions near the opening where there is a possibility that the receiver coil faces the transmitter coil, while the optical device is being held within the tubular member.

In this configuration, the user can set the viewing device within the tubular member without paying attention to the position of the receiver and transmitter coils. By simply doing this, the receiver coil and one of the transmitter coils at total four positions can be arranged face to face without fail. Therefore, the situation where the secondary battery is left uncharged can be avoided as much as possible.

The charging system of the present invention may further includes: a deviation sensor for sensing an amount of deviation of the receiver coil from a regular position to be in most proximity to the power transmitter coil, while the optical device is being held within the tubular member; and a coil movement controller for moving the transmitter coil or the receiver coil such that the amount of deviation sensed by the deviation sensor is decreased. This can prevent the charging time from being prolonged, and reduce the power loss.

Embodiments of the present invention are described below with reference to the appended drawings.

### Embodiment 1

FIG. 1 is an oblique view of a stereoscopic image viewing device being an optical device according to Embodiment 1 of the present invention. FIG. 2 is a rear view of the viewing device with the temples being folded. FIG. 3 is a functional block diagram of the stereoscopic image viewing device.

The stereoscopic image viewing device (hereinafter referred to as the “viewing device”) 10 is an eyeglasses-like viewing device compatible with an active-shutter stereoscopic image viewing system.

The active-shutter stereoscopic image viewing system is a system for viewing stereoscopic images in which right-eye and left-eye images are displayed on a display device such as a 3D television while being alternately switched at high speed, and optical shutters of the viewing device 10 are alternately opened and closed in synchronization with the switching of images on the display device.

In the viewing device 10, a driver circuit 14 is connected to the electrodes (not shown) of right-eye and left-eye optical shutters 12, and to the driver circuit 14, a power source unit 16 for driving the optical shutters 12 is connected. The power source unit 16 includes a secondary battery 30, a charge/discharge circuit 32 for controlling charge and discharge of the secondary battery 30, and a power receiver coil 34 for charging the secondary battery 30 by electromagnetic induction non-contact charging system. To the driver circuit 14, the charge/discharge circuit 32 is connected. The charge/discharge circuit 32 is connected to the secondary battery 30 and the receiver coil 34.

The optical shutters 12 are held by a pair of rims 18, respectively. The pair of rims 18 are connected at their inside edges to each other via a bridge 20. To the outside edge of each rim 18, the front end of a temple 22 is connected via a hinge 24. The temple 22 has an earpiece 26 formed at its rear end. Each rim 18 has a nose pad 28 formed near the bridge 20. The pair of rims 18, the bridge 20, the temples 22, the hinges 24, the earpieces 26, and the nose pads 28 constitute a frame 1.

The display device (not shown) (e.g., a 3D television) transmits a synchronization signal specifying the timing of opening and closing the optical shutters 12, and the bridge 20 includes a reception portion (not shown) for receiving the synchronization signal. The synchronization signal received by the reception portion is transmitted to the driver circuit 14.

The optical shutters 12 are preferably liquid crystal optical shutters, in view of the operation speed and quietness. Liquid crystal optical shutters operate so as to become transparent upon application of voltage and opaque upon removal of applied voltage.

FIG. 4 is an oblique view of the appearance of a secondary battery. The secondary battery 30 preferably has an elongated shape having an outer diameter or width D of 2 to 6 mm and a length L of 15 to 35 mm. The secondary battery 30 is preferably a non-aqueous electrolyte secondary battery, and particularly preferably a lithium ion secondary battery, because the energy density thereof is high. The secondary battery 30 is not limited to a cylindrical battery as shown in the figure, and may be secondary batteries of various shapes such as a rectangular shape. Cylindrical or rectangular batteries generally include a case being a metal can.

By sizing and shaping the secondary battery 30 as mentioned above, it is possible to arrange the secondary battery 30 near the rear end of the temple 22 or in the earpiece 26 (in the figure, in the earpiece 26), without sacrificing the design.

By setting the outer diameter or width D of the secondary battery 30 to be 2 mm or more, as compared to setting the outer diameter D to be smaller than this, it becomes easy to produce the secondary battery 30, and the production cost can be reduced. Moreover, a sufficient capacity of the secondary battery 30 can be ensured. On the other hand, by setting the outer diameter D of the secondary battery 30 to be 6 mm or less, as compared to setting the outer diameter D to be larger than this, it becomes easy to arrange the secondary battery 30 on the rear side of the viewing device, without compromising the design.

Furthermore, using a secondary battery in the power source unit 16 eliminates the need to frequently replace the battery, which improves the convenience of use of the viewing device 10. The capacity of the secondary battery 30 can be set to, for example, 10 to 100 mAh.

The case of the secondary battery 30 is formed of a non-magnetic material. Examples of the non-magnetic material include austenitic stainless steel, high manganese non-magnetic steel, and simple substance or alloy of aluminum or titanium. Nickel, if used as, for example, a component of a non-magnetic alloy such as SUS316, can also be used as a non-magnetic material forming the case. By using the above-exemplified materials as the non-magnetic material forming the case, the magnetic field will not be disturbed even when the secondary battery 30 is arranged in proximity to the receiver coil 34, and in addition, the battery shape can be stabilized.

For example, in the case of a laminate battery, if the internal pressure is raised due to gas generation, the battery will swell, and the eyeglasses containing the same may be deformed. This may make the user feel discomfort from wearing the viewing device. The secondary battery 30 of the embodiment, which includes a case made of a non-magnetic material as exemplified above, shows little deformation even when gas is generated, and can prevent the inconvenience as mentioned above.

Next, an example of the secondary battery 30 is described, in which the secondary battery 30 is a lithium ion secondary battery.

As illustrated in FIG. 5, the secondary battery 30 includes a bottomed cylindrical battery case 51, a wound electrode group 52 enclosed in the battery case 51, and an insulating gasket 61 for sealing the battery case 51. The outside surface of the battery case 51 is covered with an insulating cover 54.

The electrode group 52 includes a conductive winding core 55, a negative electrode 56, a positive electrode 57, and a separator 58 separating the negative electrode 56 from the positive electrode 57. A non-aqueous electrolyte is in contact with the electrode group 52.

The outermost round of the electrode group 52 is the positive electrode 57, and is in electrical contact with the inside surface of the battery case 51. The bottom and side surfaces of the battery case 51 are exposed outside, and serve as an external positive electrode terminal.

One end 59 of the winding core 55 is exposed outside the battery case, and severs as a negative electrode terminal. The one end of the winding core 55 is fitted through the hole of the insulating gasket 61. An insulating cap 60 is attached to the other end of the winding core 55, in order to prevent a short circuit with the battery case 51.

One end of the negative electrode 56 is welded to the winding core 55. This provides electrical connection between the negative electrode 56 and the winding core 55.

The negative electrode 56 includes a belt-like negative electrode current collector and negative electrode active material layers formed on both surfaces of the negative electrode current collector. The total thickness of the negative electrode 56 is preferably 35 to 150 μm.

The one end of the negative electrode 56 has a portion where the negative electrode current collector is exposed from both surfaces with no negative electrode active material layer formed thereon. This portion is welded to the winding core 55.

The negative electrode current collector is made of a material that does not change chemically within the potential range used for charging and discharging the negative electrode active material included.

The negative electrode active material may be, for example, a carbon material such as graphite, a silicon oxide, or an alloy containing silicon. In order to achieve a higher capacity in a small-sized battery, the capacity density of the negative electrode active material layer is preferably 1000 mAh/cm³ or more. The “capacity density” herein refers to a capacity (reversible capacity) (mAh) per cm³ of the negative electrode active material layer.

In the case where a thin film containing silicon with high capacity density is formed on the surface of the negative electrode current collector by vapor deposition, a negative electrode active material having a capacity density of as high as about 1200 to 1300 mAh/cm³ can be obtained. By increasing the energy density, a battery having a high capacity can be obtained, even though the size is small.

The negative electrode active material is preferably silicon, a silicon-containing alloy, or a silicon oxide because the capacity density thereof is high, and is particularly preferably a silicon oxide. A silicon-containing alloy and a silicon oxide exhibit comparatively large expansion and contraction during charge and discharge; however, the smaller the battery is in size, the smaller the absolute value of expansion and contraction amount is, and thus the smaller the influence of expansion and contraction is. Therefore, they are suitably used in a small-sized battery.

The silicon oxide is preferably SiOₓ where 0<x<2. The smaller “x” is, the larger the capacity of the active material is, but the larger the changes in volume of active material due to expansion and contraction during charge and discharge is. On the other hand, the larger “x” is, the smaller the changes in volume of active material due to expansion and contraction during charge and discharge is, but the more the irreversible capacity increases. In the small-sized battery of the present invention, the influence due to changes in volume of active material is comparatively small. Accordingly, 0<x≦1.1 is preferred, in view of the changes in volume of active material and the irreversible capacity of the small-sized battery.

The silicon-containing alloy is preferably an alloy of silicon and at least one element selected from the group consisting of iron, cobalt, nickel, copper, and titanium.

The winding core 55 is electrically connected to the negative electrode 56, and therefore, it suffices if it is made of a material that does not change chemically within the potential range used for charging and discharging the negative electrode active material included. Specifically, for the winding core 55, stainless steel (SUS), copper, a copper alloy, aluminum, iron, nickel, palladium, gold, silver, and platinum are used. These may be uses singly or in combination of two or more.

The winding core 55 is preferably made of the same material as the negative electrode current collector. The winding core 55 may be of any shape suitable for welding to the negative electrode 56. The winding core 55 is preferably rod-like. The rod-like winding core 55 preferably has a flat portion along the longitudinal direction thereof. The flat portion provides plane-to-plane contact with the electrode.

The positive electrode 57 at the outermost round of the electrode group includes a one-sided portion (an exposed portion of the positive electrode current collector) in which a positive electrode active material layer is formed on the inner circumferential surface of a positive electrode current collector, and no positive electrode active material layer is formed on the outer circumferential surface of the positive electrode current collector. The surface of the exposed portion of the positive electrode current collector is in close contact with the inside surface of the battery case. In this way, the positive electrode 57 is in electrical contact with the battery case 51.

The positive electrode current collector is, for example, a belt-like metal foil, and preferably is aluminum foil or aluminum alloy foil.

In view of the size reduction of the battery and the positive electrode capacity, the positive electrode active material layer preferably has a thickness (thickness per surface) of 30 to 100 μm.

The positive electrode active material layer includes a positive electrode active material, and may further include a positive electrode conductive agent and a positive electrode binder, if necessary.

The positive electrode active material is not particularly limited and may be any material that can be used in a lithium ion secondary battery. Examples of the positive electrode active material include lithium-containing transition metal oxides, such as lithium cobalt oxide (LiCoO₂), lithium nickelate (LiNiO₂), and lithium manganate (LiMn₂O₄)

In view of reducing the size of the battery and increasing the energy density, a preferable positive electrode active material is a lithium-containing composite oxide represented by the general formula: LiₓNi_{y}M_{1-y}O₂, where M is at least one selected from the group consisting of Na, Mg, Sc, Y, Mn, Fe, Co, Cu, Zn, Al, Cr, Pb, Sb, and B, 0<x≦1.2, and 0.5<y≦1.0.

In view of reducing the size of the battery and increasing the energy density, another preferable positive electrode active material is a lithium-containing composite oxide represented by the general formula: LiₓNi_{y}Co_{1-y-z}O₂, where M is at least one selected from the group consisting of Mg, Ba, Al, Ti, Sr, Ca, V, Fe, Cu, Bi, Y, Zr, Mo, Tc, Ru, Ta, and W, 0.9≦x≦1.2, 0.3≦y≦0.9, 0.05≦z≦0.5, and 0.01≦1≦y-z≦0.3.

Next, one example of the production method of the secondary battery 30 is described.

The battery constituent members: the insulating gasket 61, the winding core 55, the negative electrode 56, the positive electrode 57, the separator 58, and the battery case 51, are allowed to stand under vacuum at 100° C., to dry each member. Thereafter, in an atmosphere with a dew point of −50° C. or less, the battery is produced as follows.

The winding core 55 used here is, for example, a round bar (diameter: 1 mm) made of stainless steel. The portion of the negative electrode 56 where the negative electrode current collector is exposed is overlapped with the winding core 55, and a needle-like first resistance welding electrode and a flat plate-like second resistance welding electrode are arranged in opposite to each other, with the negative electrode 56 and the winding core 55 interposed therebetween. The first and second resistance welding electrodes are brought into contact with the surface of the negative electrode 56, and the current collector, respectively, and in this state, an electrical current is applied across the first and second resistance welding electrodes, to bond the negative electrode 56 to the current collector by resistance welding at several points along the axial direction X of the winding core 55.

Subsequently, the negative electrode 56 is wound together with the separator 58 and the positive electrode 57 around the current collector, to form the wound electrode group 52 as illustrated in FIG. 5. Upon winding of the negative electrode 56, the positive electrode 57, and the separator 58, a polypropylene adhesive tape may be attached to the outermost round of the electrode group, to secure the electrode group so as not to become loose. Then, the one end 59 of the winding core 55 is fitted through into the hole of the insulating gasket 61, and the other end thereof is provided with the insulating cap 60.

The electrode group 52 is allowed to stand still in a plastic container, and then, an electrolyte is poured into the container, to immerse the electrode group 52 in the electrolyte. Subsequently, the electrolyte is impregnated into the electrode group 52 under reduced pressure.

The electrode group 52 including the electrolyte is taken out of the container, and inserted into a bottomed cylindrical battery case made of aluminum (outer diameter: 4 mm, height: 20 mm). The insulating gasket 61 is positioned at the opening of the battery case 51, and an opening end 31 of the battery case 51 is clamped onto the top of the insulating gasket 61, to seal the battery case 51. In such a manner, a small-sized lithium ion secondary battery (outer diameter: 4 mm, height: 20 mm) having a nominal capacity of, for example, 18 mAh can be obtained. The secondary battery may not necessarily have the above external dimensions, and it suffices if it is of an elongated cylindrical shape having, for example, an outer diameter D of 2 to 6 mm, and a length L of 15 to 35 mm.

In the viewing device 10 as illustrated, as shown in FIG. 1, the driver circuit 14 is disposed in the earpiece 26 on the right side (on the depth side of the figure), and the power source unit 16 is disposed in the earpiece 26 on the left side (on the front side of the figure). The arrangement of each member is not limited to this, and at least one or all of the members constituting the power source unit 16 and the driver circuit 14 can be disposed near the rear ends of the right and left temples 22. Alternatively, of the power supply unit 16, the charge/discharge circuit 32 can be moved onto the right side, with only the secondary battery 30 being left on the left side, so that the left side and the right side are balanced.

Here, it is not requisite to dispose the driver circuit 14 and the power source unit 16 entirely near the rear ends of the temples 22 or in the earpieces 26, and a part of them (e.g., the driver circuit 14) can be disposed near the front end of the temple 22 or in the rim 18.

However, since the secondary battery 30 has a comparatively large weight, it is preferable to dispose the secondary battery 30 near the rear end of the temple 22 or in the earpiece 26. And in order to shorten the length of wiring as much as possible, it is preferable to dispose the receiver coil 34 also near the rear end of the temple 22 or in the earpiece 26 on the same side as that of the secondary battery 30.

At this time, it is preferable to position the members of the driver circuit 14 and the power source unit 16 such that, with the distance between the front end of the temple 22 (e.g., the center point on the shaft of the hinge 24) and the tip of the earpiece 26 (the distance along the direction in which the temple extends) being taken as 100%, the center of gravity G of the viewing device 10 is positioned at a distance of 15 to 50% from the front end of the temple 22. When the center of gravity of the viewing device 10 is within the above range, the comfort of wearing the viewing device 10 is remarkably good.

FIG. 6 illustrates an exemplary housing portion for accommodating the driver circuit and the power source unit. A housing portion 36 is formed as a hollow portion provided in each of the right and left temples 22 so that the driver circuit 14 and the power source unit 16 can be incorporated in the temples 22. The housing portion 36 can be provided with a lid that can be opened and closed.

The shape of the housing portion 36 is not limited to a rectangular shape as shown in the figure, and if the cross section of the temple 22 is rounded, the housing portion 36 can be cylindrical or the like correspondingly. The size of the housing portion 36 is appropriately set, depending on the size of an object to be accommodated therein. Alternatively, the housing portion 36 may be provided in the earpieces 26 as shown in FIG. 1.

Since the housing portion 36 comprises a hollow portion provided in the temples 22 or the earpieces 26, members of the driver circuit 14 and the power source unit 16, in particular, the secondary battery 30, the size of which is relatively difficult to reduce, can be incorporated in the temples 22 or the earpieces 26. Therefore, these members can be accommodated without causing the user to be aware of their presence. This broadens the choice of designs of the viewing device 10, making it easy to improve the appearance.

Furthermore, since the power source unit 16 uses the secondary battery 30 in place of a conventional primary battery, there is less need to replace the battery. Therefore, if the temples 22 or the earpieces 26 are made of resin, the power source unit 16 and the driver circuit 14 may be embedded in the temples 22 or the earpieces 26 by insert molding. This further increases the flexibility in designing the viewing device.

As illustrated in FIG. 7, in non-contact charging of the secondary battery 30 using the receiver and transmitter coils 34 and 38, the receiver coil 34 and the transmitter coil 38 are arranged coaxially face to face. In this state, by passing an alternating current through the transmitter coil 38, the magnetic flux through the coils is varied over time. The changes of the magnetic flux generate electromotive force in the receiver coil 34. The secondary battery 30 is charged by the electromotive force.

At this time, it is preferable to set the distance between the receiver coil 34 and the secondary battery 30 to 4 cm or less, in order to shorten the length of wiring. The receiver coil 34 is preferably positioned such that the axis thereof is perpendicular to the side surface of the earpiece 26.

FIG. 8 illustrates an exemplary charger for charging the secondary battery.

A charger 40 includes a holder 42 comprising a tubular member having an opening 42a and a bottom 42b. The holder 42 holds the viewing device 10 with the temples being folded, in such a state that the outside edge of one of the rims 18 is directed toward the opening 42a, and the outside edge of the other of the rims 18 is directed toward the bottom 42b.

The charger 40 has a connector terminal (not shown) for connecting the charger with an external power source for supplying electricity to the transmitter coil 38. The charger 40 may further have a controller unit for controlling a current to be supplied to the transmitter coil 38. The controller unit can be composed of, for example, a central processing unit (CPU), a micro processing unit (MPU), and a memory.

The opening 42a and the bottom 42b are each shaped asymmetric so that the orientation of the top and bottom and the front and back of the viewing device 10 relative to the holder 42 can be uniquely determined, while the viewing device 10 with the temples 22 being folded is being held within the holder 42. The holder 42 is provided with the transmitter coil 38 such that it is coaxially aligned with and faces the receiver coil 34, while the viewing device 10 is being held within the holder 42, with the portion provided with the receiver coil 34 being directed toward the bottom 42b. Alternatively, the transmitter coil 38 may be provided near the opening of the holder 42, and the opening 42a may be shaped such that the portion provided with the receiver coil 34 of the viewing device 10 held within the holder is directed toward the opening.

As illustrated in FIG. 9, a mark 44 indicating the position where the transmitter coil 38 is provided is formed on the side surface of the holder 42 at a position corresponding to the position where the transmitter coil 38 is provided. Correspondingly thereto, as illustrated in FIG. 2, a mark 46 is formed on the earpiece 26 of the viewing device 10 at a position corresponding to the position where the receiver coil 34 is provided.

The above configuration allows the user to insert the viewing device 10 into the holder 42, with the portion provided with the receiver coil 34 being directed toward the bottom, and the top and bottom and the front and back of the viewing device 10 being oriented as determined by the shape of the opening 42a. As such, the user can easily place the viewing device 42 into the holder 42 such that the receiver coil 34 and the transmitter coil 38 face each other.

FIG. 10 illustrates a variant of the charger. In a charger 40A, a holder 42A has an oblate opening 42a and an oblate bottom 42b. The transmitter coil 38 is disposed at a pair of positions near the bottom 42b and a pair of positions near the opening 42a. The positions at which the transmitter coil 38 is provided correspond to four possible postures (two (front/back and reversed front/back)×two (top/bottom and reversed top/bottom)) of the viewing device 10 held within the holder 42A.

Since the transmitter coils 38 are arranged as above, non-contact charging of the secondary battery 30 is made possible, even though the user pays no attention to the positions of the receiver and transmitter coils 34 and 38. This further improves the convenience of use of the viewing device 10.

It is noted that, as long as four transmitter coils 38 are connected in series, charging is possible regardless of which one of the transmitter coils 38 faces the receiver coil 34.

In the case of connecting four transmitter coils 38 in parallel with an external power source, a sensor mechanism for sensing which one of the transmitter coils 38 faces the receiver coil 34 should be provided. For example, the transmitter coil 38 facing the receiver coil 34 can be identified by sensing an impedance of each transmitter coil 38 when short-time current is passed therethrough. On the basis of the sensing results, the power to each transmitter coil 38 is selectively turned on or off. Such a mechanism can be provided in the controller unit of the charger 40.

Next, Embodiment 2 of the present invention is described.

### Embodiment 2

FIG. 11 illustrates a lens for use in variable focus eyeglasses being an optical device according to Embodiment 2, as viewed from a direction perpendicular to an incident direction of light. The appearance of the variable focus eyeglasses themselves is similar to that of the viewing device in FIG. 1. Therefore, similar portions are denoted by the same reference numerals as in FIG. 1. In addition, the thickness ratio and other ratios among the portions shown in FIG. 11 are changed from the actual ratio for better visibility.

Lens 70 illustrated in the figure includes a base lens 70a, and a planar electroactive element 71 embedded in the base lens 70a. For example, a normal optical lens (concave lens) for myopia correction can be used as the base lens 70a. The electroactive element 71 is a device having a refractive index that is variable in response to application of electrical energy. The electroactive element 71 is in optical communication with the base lens 70a. The lens 70 can be attached to the frame 1 (more specifically, the rim 18) in FIG. 1. Note that the electroactive element 71 can be attached to the surface of the base lens 70a, instead of inside the base lens 70a.

The electroactive element 71 can be disposed over the entire or partial field of view of the lens 70. In FIG. 11, the dash-dot-dot line indicates the electroactive element 71 being disposed over the entire field of view of the lens 70. The electroactive element 71 can be planar as illustrated in the figure or can be bent along the curved surface of the lens. The electroactive element 71 can be disposed in both or only one of the pair of lenses 70. The number of electroactive elements 71 disposed in one lens 70 is not limited to one. Two or more electroactive elements 71 can be disposed in one lens 70. In one possible example, the lenses 70 can be made of mere transparent material having no refractive power for myopia or hyperopia correction, and both an electroactive element 71 that exerts a refractive power for myopia correction upon activation and another electroactive element 71 that exerts a refractive power for hyperopia correction upon activation can be disposed in one lens 70.

When the electroactive element 71 is disposed over only a portion of the entire field of view of the lens 50, the position of the electroactive element 71 in the lens 70 is not specifically limited. For example, the electroactive element 71 can be disposed in such a position that overlaps with the user's viewing direction when the user looks down, i.e., in the center of a lower part of the lens 70.

FIG. 12 is a cross-sectional view of an exemplary electroactive element. In this figure, the thickness to width ratio of the electroactive element 71 and the thickness ratio among the layers do not reflect the actual ratio. In the figure, the electroactive element 71 is enlarged mainly in the thickness direction.

The electroactive element 71 illustrated in the figure includes two transparent substrates 72 and an electroactive material 73 provided therebetween and made of a thin layer of liquid crystal material. The substrates 72 are formed so as to hold the electroactive material 73 therebetween and ensure that the electroactive material 73 cannot leak out. The thickness of each substrate 72 is, for example, greater than 100 μm but less than 1 mm, and preferably on the order of 250 μm. The thickness of the electroactive material 73 is, for example, less than 100 μm, and preferably, less than 10 μm.

One of the two substrates 72 can be a part of the base lens 70a. At this time, one of the substrates 72 can be essentially thicker than the other. In these modes, the thickness of the substrate being a part of the base lens 70a is, for example, on the order of 1 to 12 mm. The thickness of the other substrate 72 is, for example, greater than 100 μm but less than 1 mm, and preferably on the order of 250 μm.

The two substrates 72 can have the same refractive index. The electroactive material 73 can include liquid crystals. Liquid crystals have a refractive index that is variable upon generation of electric fields across the liquid crystals, and therefore are particularly suitable for the electroactive material 73. The liquid crystal material is preferably insensitive to polarized light. A cholesteric liquid crystal material can be appropriately used as the liquid crystal material. The cholesteric liquid crystal material can include nematic liquid crystals with a birefringence of about 0.2 or more. The cholesteric liquid crystal material can further include chiral dopants with a helical twisting power of about 1.1 (μm⁻¹) or more. The electroactive material 73 can have an average refractive index approximately equal to the aforementioned refractive index.

Each substrate 72 has an optically transparent electrode 74 provided on its surface that contacts the electroactive material 73. Once the electroactive material 73 is activated through voltage application by the electrodes 74, the refractive index of the electroactive material 73 varies, which changes the optical characteristics, such as focal distance and diffraction efficiency, of the electroactive material 73. The electrode 74 can include for example, any known transparent conductive oxide (e.g., ITO (indium tin oxide or tin-doped indium oxide), or conducting organic material (e.g., PEDOT:PSS (Poly(3,4-ethylenedioxythiophene)poly(styrenesulfonate)), or carbon nanotubes). The thickness of the electrode 74 is, for example, less than 1 μm, and preferably, less than 0.1 μm.

The electroactive element 71 has a refractive index which is switchable between first and second refractive indices, and can have a first refractive power in an inactive state where applied voltage is less than a first predetermined value E₁, and a second refractive power in an active state where applied voltage is greater than a second predetermined value E₂ (E₂>E₁).

The electroactive element 71 can be configured so as to exert substantially no refractive index power in the inactive state. In other words, when a voltage of less than the first predetermined value E₁ is applied (or when substantially no voltage is applied), the electroactive material 73 can have substantially the same refractive index as the substrate 72. In such a case, the electroactive element 71 has a substantially constant refractive index across its thickness, and the refractive index will not change.

On the other hand, upon application of a sufficient voltage (a voltage exceeding the second predetermined voltage E₂) to cause the director of, for example, the cholesteric liquid crystal material included in the electroactive material 73 to align parallel to an electric field to be generated, the electroactive element 71 can be in an active state so as to increase the refractive index. In other words, when a voltage exceeding the second predetermined voltage E₂ is applied, the cholesteric liquid crystal material can have a refractive index different from the refractive index of the substrate 72.

For example, when the user is engaged in a long-distance activity such as driving a car, the electroactive element 71 is deactivated, so that the user can have appropriate correction for long distance by the base lens 70a. On the other hand, when the user is engaged in a short- or middle-distance activity such as reading a book or viewing a computer screen, the electroactive element 71 is activated, so that the user can have appropriate correction for short distance.

The cholesteric liquid crystal material included in the electroactive material 73 is essentially cholesteric (i.e., chiral or twisted) or it is formed by mixing nematic liquid crystals with a chiral twist agent. In the case of the latter approach, the resultant cholesteric liquid crystals have many of the same properties as the original nematic liquid crystals. For example, the resultant cholesteric liquid crystal material can have the same dispersion of the refractive index. Moreover, the resultant cholesteric liquid crystal material has the same ordinary and extraordinary refractive indices as the original nematic liquid crystals. More nematic materials are commercially available than cholesteric liquid crystals, and therefore the latter approach is preferable and offers greater design flexibility.

The variable focus eyeglasses can include a driver circuit for applying a predetermined voltage to each of the electrodes 74. The driver circuit is a similar driver circuit to the driver circuit 14 in Embodiment 1, and can operate in such a manner as to apply a predetermined voltage to each of the electrodes 74 in response to, for example, the user's button operation or according to a result of detecting the user's predetermined action (e.g., the action of lowering the head). Such a driver circuit can be provided in the temple 22 or the earpiece 26 in the same arrangement as the driver circuit 14 in Embodiment 1.

The variable focus eyeglasses can further include a power source unit connected to the driver circuit so as to be able to control the electroactive element 71. The power source unit has similar components to those of the power source unit 16 in FIG. 3, and operates in a similar manner. Such a power source unit can be provided in the temple 22 or the earpiece 26 in the same arrangement as the power source unit 16.

Next, Embodiment 3 of the present invention is described.

### Embodiment 3

FIG. 13 is a side view of a charger 80 used in a charging system according to Embodiment 3. The shape of the charger 80 is similar to that of the charger 40 of FIG. 8 or the charger 40A of FIG. 10. The charger 80 differs from those charges in that the transmitter coil 38 is movable. The charger 80 as illustrated is provided with only one transmitter coil 38, as in the charger 40 of FIG. 8. Alternatively, the charger 80 may be provided with four transmitter coils 38, as in the charger 40A of FIG. 10. In the charger 80 as illustrated, the initial position of the transmitter coil 38 is the same as that of the transmitter coil 38 in the charger 40 of FIG. 8.

The charger 80 includes a magnetic flux density detector coil 81 for detecting a magnetic flux density (a first magnetic flux density) at a first point around the initial position of the transmitter coil 38, a magnetic flux density detector coil 82 for detecting a magnetic flux density (a second magnetic flux density) at a second point around the initial position of the transmitter coil 38, and a magnetic flux density detector coil 83 for detecting a magnetic flux density (a third magnetic flux density) at a third point around the initial position of the transmitter coil 38.

The charger 80 further includes an actuator 84 for moving the transmitter coil 38 so as to be attracted toward the first point, an actuator 85 for moving the transmitter coil 38 so as to be attracted toward the second point, and an actuator 86 for moving the transmitter coil 38 so as to be attracted toward the third point. The actuators 84 to 86 are controlled by an actuator controller 87. The actuator controller 87 can be composed of, for example, a CPU, MPU, and memory. The first to third points are not particularly limited and may be any points that do not overlap, and for example, fall on the vertices of a regular triangle whose center coincides with the center of the axis of the transmitter coil 38 at the first position.

The charger 80 further includes a deviation sensor 80 for sensing an amount of deviation of the receiver coil 34 from its regular position to be in most proximity to the transmitter coil 38, or to coaxially face the transmitter coil 38, while the optical device is being held within the holder of the charger 80. When the receiver coil 34 is in its regular position, that is, the receiver coil 34 and the transmitter coil 38 are arranged coaxially face to face, the secondary battery can be charged with the highest efficiency.

The deviation sensor 88 senses the aforementioned amount of the deviation on the basis of the magnetic flux densities detected by the magnetic flux density detector coils 81 to 83. The actuator controller 87 controls the actuators 84 to 86 such that the transmitter coil 38 is moved in a direction that allows the amount of deviation sensed by the deviation sensor 88 to be decreased. In this regard, description is given below.

The vector starting from a position corresponding to the center of axis of the transmitter coil 38 in the initial position (hereinafter referred to as the “transmitter coil center position”) and ending at a position where the magnetic flux density detector coil 81 is disposed (the first point) is defined as a first unit vector. The vector starting from the transmitter coil center position and ending at a position where the magnetic flux density detector coil 82 is disposed (the second point) is defined as a second unit vector. The vector starting from the transmitter coil center position and ending at a position where the magnetic flux density detector coil 83 is disposed (the third point) is defined as a third unit vector.

The deviation sensor 88 detects the amount of deviation (the amount of vectors) by the computation: (First magnetic flux density×First unit vector)+(Second magnetic flux density×Second unit vector)+(Third magnetic flux density×Third unit vector). The electromotive force to be generated in the magnetic flux density detector coils 81 to 83 is proportional to the rate of change over time of the magnetic flux density. Therefore, the magnetic flux density can be easily determined from the electromotive force.

The actuator controller 87 controls the actuators 84 to 86 such that the transmitter coil 38 is moved in a direction and by a distance that reduces the computed amount of deviation to be zero. As a result, the transmitter coil 38 can be positioned so as to concentrically face the receiver coil 34, and therefore, the battery can be charged with the highest efficiency and within a possible shortest period of time.

Although the transmitter coil 38 is moved so as to decrease the amount of deviation in Embodiment 3, this should not be construed as limitation, and the receiver coil 34 may be moved. In the case of moving the receiver coil 34, a mechanism for moving the receiver coil can be provided in the optical device. In this case, however, the optical device becomes heavy in weight and the range of movement is limited. Alternatively, both the transmitter and receiver coils may be moved.

### INDUSTRIAL APPLICABILITY

The optical device of the present invention is comfortable to wear and convenient to use, and therefore, in the form of so-called 3D eyeglasses, it is useful for 3D image viewing for a long time in a movie theater and 3D image viewing on a 3D television in a household with small children. Moreover, in the form of variable focus eyeglasses supposed to be always worn, a good convenience provides greater benefit to the user.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Stereoscopic image viewing device
12 Optical shutter
81 Driver circuit
83 Power supply unit
22 Temple
26 Earpiece
30 Secondary battery
32 Charge/discharge circuit
34 Receiver coil
36 Housing portion
38 Transmitter coil
40, 40A, 80 Charger
50 Lens
51 Electroactive element
81, 82, 83 Magnetic flux density detector coil
84, 85, 86 Actuator
87 Actuator controller
88 Deviation sensor

1. An optical device comprising: one or more optical components configured to be electrically actuated such that light transmission states are variable, a driver circuit for the optical components, a power source unit for driving the optical components, a pair of rims for supporting the optical components, a pair of temples having front and rear ends and being connected at the front ends to the pair of rims, and a pair of earpieces formed at the rear ends of the pair of temples,
the power source unit including a secondary battery, and a power receiver coil for charging the secondary battery, and
the secondary battery including a case made of a non-magnetic material.

2. The optical device according to claim 1, wherein
the secondary battery and the power receiver coil are provided near the rear end of the same temple or in the same earpiece, and
a distance between the front end of the temple and a center of gravity of the optical device along a direction in which the temple extends is 15 to 50% of a distance between the front end of the temple and a rear end of the earpiece along the direction in which the temple extends.

3. The optical device according to claim 1, wherein the secondary battery is cylindrical or rectangular.

4. The optical device according to claim 3, wherein the secondary battery has a diameter or width of 2 to 6 mm.

5. The optical device according to claim 1, wherein a distance between the secondary battery and the power receiver coil is 4 cm or less.

6. The optical device according to claim 1, wherein the non-magnetic material includes at least one selected from the group consisting of austenitic stainless steel, high manganese non-magnetic steel, nickel, aluminum, and titanium.

7. The optical device according to claim 1, wherein:
the optical components are a pair of liquid crystal optical shutters supported by the pair of rims; and
the driver circuit applies a variable voltage to each of the pair of liquid crystal optical shutters in synchronization with switching between two types of images alternately displayed on an external image display device, such that when a degree of transparency of one of the pair of liquid crystal optical shutters is high, a degree of transparency of the other is low, and when the degree of transparency of one of the pair of liquid crystal optical shutters is low, the degree of transparency of the other is high.

8. The optical device according to claim 1, wherein: the optical components include an electroactive material whose refractive index varies upon activation through application of a voltage greater than or equal to a predetermined value; and the driver circuit activates the electroactive material by applying the voltage greater than or equal to the predetermined value to the electroactive material.

9. A charging system comprising:
the optical device of claim 1; and
a charger comprising a holder for holding the optical device in a predetermined posture, and a power transmitter coil for charging the secondary battery, in cooperation with the power receiver coil,
the holder holding the optical device such that the power receiver coil is in proximity to the power transmitter coil.

10. The charging system according to claim 9, wherein:
each of the pair of temples is connected at the front end thereof to an outside edge of each of the pair of rims so as to be foldable about a hinge;
the holder of the charger is a tubular member having an opening at one end thereof and has a bottom at the other end thereof;
the holder holds the optical device with the pair of temples being folded, within the tubular member in such a state that the outside edge of one of the rims is directed toward the opening, and the outside edge of the other of the rims is directed toward the bottom; and
the power transmitter coil is disposed at a position in proximity to the power receiver coil, while the optical device is being held within the tubular member.

11. The charging system according to claim 10, wherein:
the temple or the earpiece provided with the power receiver coil has a first mark indicating the position where the power receiver coil is provided; and
the tubular member has a second mark indicating the position where the power transmitter coil is provided.

12. The charging system according to claim 11, wherein:
the opening has an asymmetric shape, and when the optical device with the temples being folded is to be held within the tubular member, orientations of the optical components and the temples and orientations of one and the other of the rims of the optical device are determined by the shape of the opening.

13. The charging system according to claim 9, wherein:
each of the pair of temples is connected at the front end thereof to an outside edge of each of the pair of rims so as to be foldable about a hinge;
the holder of the charger is a tubular member having an opening at one end thereof and has a bottom at the other end thereof;
the secondary battery and the power receiver coil are provided near the rear end of the same temple or in the same earpiece;
the holder holds the optical device with the temples being folded, within the tubular member in such a state that the outside edge of one of the rims is directed toward the opening, and the outside edge of the other of the rims is directed toward the bottom; and
the power transmitter coil is disposed at each of a pair of positions near the bottom and each of a pair of positions near the opening where there is a possibility that the power receiver coil faces the power transmitter coil, while the optical device is being held within the tubular member.

14. The charging system according to claim 9, further comprising:
a deviation sensor for sensing an amount of deviation of the power receiver coil from a regular position to be in most proximity to the power transmitter coil, while the optical device is being held within the holder; and
a coil movement controller for moving the power transmitter coil or the power receiver coil such that the amount of deviation sensed by the deviation sensor is decreased.
